(19) United States
(12) Patent Application Publication
(10) Pub. No.: US 2023/0108713 A1
(43) Pub. Date: Apr. 6, 2023

(54) MACHINE LEARNING METHOD TO DETERMINE THE QUALITY AND/OR VALUE OF ANY SEAT IN AN EVENT VENUE

(71) Applicant: StubHub, Inc., San Francisco, CA (US)

(72) Inventors: Corey James Reed, Oakland, CA (US); Dirk Daniel Sierag, Lynnwood, WA (US)

(21) Appl. No.: 17/494,766

(22) Filed: Oct. 5, 2021

(51) Int. Cl. G06Q 30/02; G06N 20/00

(52) U.S. Cl. CPC G06Q 30/0283; G06N 20/00

(57) ABSTRACT

Methods, systems, and storage media for determining the inherent quality of seats within an event venue and for determining the value of prices of tickets for seats within an event venue are disclosed. Exemplary implementations may: utilize data related to past transactions for tickets and event venue information (e.g., locations of zones, sections, rows, and the like) to train a machine-learning model to determine a seat desirability score for seats in an event venue; determine the best quality seats that are available for future events at the event venue using the seat desirability score; determine a pricing value for tickets in the event venue using the seat desirability score and a ticket price associated with available ticket listings, and display one of one or more seats with the strongest seat desirability score and/or having the strongest pricing value for a ticket-requesting buyer.

### TECHNICAL FIELD

The present disclosure generally relates to electronic commerce. More particularly, the present disclosure relates to determining the quality of seats and/or the value of prices for tickets for seats for events at event venues.

### BACKGROUND

The online purchasing of tickets for events is very common. For instance, tickets for concerts and sporting events can be purchased directly from an online ticket vendor or from a secondary ticket marketplace, such as StubHub, Inc. The tickets can be paid for via a payment provider account, such as that offered by PayPal, Inc. After the tickets are paid for, the purchased tickets then can be mailed to the buyer, printed by the buyer, and/or electronically transmitted to the buyer such that the tickets may be redeemable directly from the buyer's electronic device.

### BRIEF SUMMARY

The subject disclosure provides for systems and methods for determining the quality of seats and/or the value of prices for tickets for seats for events at event venues. Data related to past transactions for tickets and event venue information (e.g., locations of zones, sections, rows, and the like) may be used to train a machine-learning model to quantify the desirability of one or more seats for events at event venues. The trained machine-learning model then may be used to determine seat desirability scores for seats for events at an event venue. The resulting seat desirability scores may be used to determine the best seats that are available for future events at the event venue. The seat desirability score and a ticket price associated with available ticket listings for future events may be used to determine a pricing value for seats at the event venue. The seat desirability score and/or pricing value may be utilized to guide buyers in selecting desired seats for the future events. The seat desirability score and/or pricing value also may be utilized to guide prospective ticket sellers in setting a price for their available event tickets.

One aspect of the present disclosure relates to a computer-implemented method for determining the quality of seats and/or the value of prices for tickets for seats for events at event venues. The method may include obtaining, from a ticket server, a plurality of ticket listings for events at an event venue, the plurality of ticket listings being capable of being served to buyers. At least a portion of the plurality of ticket listings may include one or more of a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings. The method may include executing a trained machine-learning model on at least the portion of the plurality of ticket listings to obtain a seat desirability score for one or more seats associated with the portion of the plurality of ticket listings. The method may include determining a pricing value for the portion of the plurality of ticket listings. The method may include causing display of at least one of the seat desirability score and the pricing value for at least one of the one or more seats associated with the portion of the plurality of ticket listings.

In some aspects, the computer-implemented method further may include obtaining transaction data pertaining to a plurality of past ticket transactions. At least a portion of the plurality of past ticket transactions may be associated with one or more seats for a past event at the event venue. The transaction data may include one or more of: a type of event of the past event associated with at least the portion of the plurality of past ticket transactions, a venue seat configuration for the event associated with at least the portion of the plurality of past ticket transactions, and a seat identifier identifying one or more seats associated with at least the portion of the plurality of past ticket transactions.

In some aspects, the computer-implemented method further may include obtaining event venue manifest data. At least a portion of the event venue manifest data may include one or more of: a type of event for which an associated event venue is used, and a venue seat configuration associated with at least a portion of the event types. The event venue seat configuration may include a seat identifier and a seat location for at least a portion of the seats at the event venue. The event venue seat configuration may also include descriptions and locations of point(s) of interest, such as a stage or field.

In some aspects, the computer-implemented method further may include training a machine-learning model using transaction data and event venue manifest data to obtain a trained machine learning model that can determine a seat desirability score for a plurality of seats at the event venue. The seat desirability score for at least a portion of the plurality of seats at the event venue may be dependent upon an event at the event venue. The event may be associated with an event venue seat configuration and a type of event.

Another aspect of the present disclosure relates to a system configured for determining the quality of seats and/or the value of prices for tickets for seats for events at event venues. The system may include one or more hardware processors configured by machine-readable instructions. The processor(s) may be configured to obtain, from a ticket server, a plurality of ticket listings for events at an event venue, the plurality of ticket listings being capable of being served to buyers. At least a portion of the plurality of ticket listings may include one or more of a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings. The processor(s) may be configured to execute a trained machine-learning model on at least the portion of the plurality of ticket listings to obtain a seat desirability score for one or more seats associated with the portion of the plurality of ticket listings. The processor(s) may be configured to determine a pricing value for the portion of the plurality of ticket listings. The processor(s) may be configured to cause display of at least one of the seat desirability score and the pricing value for at least one of the one or more seats associated with the portion of the plurality of ticket listings.

In some aspects, the processor(s) further may be configured to obtain transaction data pertaining to a plurality of past ticket transactions. At least a portion of the plurality of past ticket transactions may be associated with one or more seats for a past event at the event venue. The transaction data may include one or more of: a type of event of the past event associated with at least the portion of the plurality of past ticket transactions, a venue seat configuration for the event associated with at least the portion of the plurality of past ticket transactions, and a seat identifier identifying one or more seats associated with at least the portion of the plurality of past ticket transactions.

In some aspects, the processor(s) further may be configured to obtain event venue manifest data. At least a portion of the event venue manifest data may include one or more of: a type of event for which an associated event venue is used, and a venue seat configuration associated with at least a portion of the event types. The event venue seat configuration may include a seat identifier and a seat location for at least a portion of the seats at the event venue. The event venue seat configuration may also include descriptions and locations of point(s) of interest, such as a stage or field.

In some aspects, the processor(s) further may be configured to train a machine-learning model using transaction data and event venue manifest data to determine a seat desirability score for a plurality of seats at the event venue and to obtain a trained machine-learning model. The seat desirability score for at least a portion of the plurality of seats at the event venue may be dependent upon an event at the event venue. The event may be associated with an event venue seat configuration and a type of event.

Yet another aspect of the present disclosure relates to a non-transient computer-readable storage medium having instructions embodied thereon, the instructions being executable by one or more processors to perform a method for determining the quality of seats and/or the value of prices for tickets for seats for events at event venues. The method may include one or more hardware processors configured by machine-readable instructions. The processor(s) may be configured to obtain, from a ticket server, a plurality of ticket listings for events at an event venue, the plurality of ticket listings being capable of being served to buyers. At least a portion of the plurality of ticket listings may include one or more of a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings. The processor(s) may be configured to execute a trained machine-learning model on at least the portion of the plurality of ticket listings to obtain a seat desirability score for one or more seats associated with the portion of the plurality of ticket listings. The processor(s) may be configured to determine a pricing value for the portion of the plurality of ticket listings. The processor(s) may be configured to cause display of at least one of the seat desirability score and the pricing value for at least one of the one or more seats associated with the portion of the plurality of ticket listings.

In some aspects, the one or more hardware processors further may be configured by the machine-readable instructions to receive a new ticket listing for one or more tickets capable of being served to buyers by the ticket server. The new ticket listing may include one or more of: an event venue identifier identifying an event venue pertaining to the new ticket listing, a type of event pertaining to the new ticket listing, a seat identifier identifying a seat associated with the new ticket listing, and a price for the seat associated with the new ticket listing. In some aspects, the one or more hardware processors further may be configured by the machine-readable instructions to execute the trained machine-learning model on the new ticket listing to obtain a seat desirability score for the seat associated with the new ticket listing. In some aspects, the one or more hardware processors further may be configured by the machine-readable instructions to determine a pricing value for the seat associated with the new ticket listing. In some aspects, the one or more hardware processors further may be configured by the machine-readable instructions to store the new ticket listing with the seat desirability score and pricing value for the seat associated therewith in the lookup table.

Still another aspect of the present disclosure relates to a computer-implemented method for determining the quality of seats and/or the value of prices for tickets for seats for events at event venues. The method may include means for obtaining, from a ticket server, a plurality of ticket listings for events at an event venue, the plurality of ticket listings being capable of being served to buyers. At least a portion of the plurality of ticket listings may include one or more of a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings. The method may include means for executing a trained machine-learning model on at least the portion of the plurality of ticket listings to obtain a seat desirability score for one or more seats associated with the portion of the plurality of ticket listings. The method may include means for determining a pricing value for the portion of the plurality of ticket listings. The method may include means for storing at least the portion of the plurality of ticket listings with the seat desirability score for the one or more seats and the pricing value associated therewith in a lookup table. The method may include means for causing display of at least one of the seat desirability score and the pricing value for at least one of the one or more seats associated with the portion of the plurality of ticket listings.

In some aspects, the computer-implemented method further may include means for obtaining transaction data pertaining to a plurality of past ticket transactions. At least a portion of the plurality of past ticket transactions may be associated with one or more seats for a past event at the event venue. The transaction data may include one or more of: a type of event of the past event associated with at least the portion of the plurality of past ticket transactions, a venue seat configuration for the event associated with at least the portion of the plurality of past ticket transactions, and a seat identifier identifying one or more seats associated with at least the portion of the plurality of past ticket transactions. In some aspects, the computer-implemented method further may include means for obtaining event venue manifest data. At least a portion of the event venue manifest data may include one or more of: a type of event for which an associated event venue is used, and a venue seat configuration associated with at least a portion of the event types. The event venue seat configuration may include a seat identifier for at least a portion of the seats at the event venue. In some aspects, the computer-implemented method further may include means for training a machine-learning model using transaction data and event venue manifest data to determine a seat desirability score for a plurality of seats at the event venue and to obtain a trained machine-learning model. The seat desirability score for at least a portion of the plurality of seats at the event venue may be dependent upon an event at the event venue. The event may be associated with an event venue seat configuration and an event type.

In some aspects, the computer-implemented method further may include means for receiving a new ticket listing for one or more tickets capable of being served to buyers by the ticket server. The new ticket listing may include one or more of: an event venue identifier identifying an event venue pertaining to the new ticket listing, a type of event pertaining to the new ticket listing, a seat identifier identifying a seat associated with the new ticket listing, and a price for the seat associated with the new ticket listing. In some aspects, the computer-implemented method further may include means for executing the trained machine-learning model on the new ticket listing to obtain a seat desirability score for the seat associated with the new ticket listing. In some aspects, the computer-implemented method further may include means for determining a pricing value for the seat associated with the new ticket listing.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a system configured for determining the quality and/or value of seats at event venues, according to certain aspects of the present disclosure.

FIG. 1B is a block diagram showing more detailed information for the machine-learning model training module of the system of FIG. 1, in accordance with one or more implementations.

FIG. 1C is a block diagram showing more detailed information for the machine-learning model execution module of the system of FIG. 1, in accordance with one or more implementations.

FIG. 1D is a block diagram showing more detailed information for the ticket serving module (i.e., ticket server) of the system of FIG. 1, in accordance with one or more implementations.

FIG. 2 illustrates an exemplary flow diagram for determining the quality and/or value of seats at event venues, according to certain aspects of the disclosure.

FIG. 3 illustrates an exemplary flow diagram for serving tickets for at least one of the best quality seat and/or the best value seat for events at event venues, according to certain aspects of the disclosure.

FIG. 4 is a block diagram illustrating an exemplary computing system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The online purchasing of tickets for events is very common. For instance, tickets for concerts and sporting events can be purchased directly from an online ticket vendor or from a secondary ticket marketplace, such as StubHub, Inc. The tickets can be paid for via a payment provider account, such as that offered by PayPal, Inc. After the tickets are paid for, the purchased tickets then can be mailed to the buyer, printed by the buyer, and/or electronically transmitted to the buyer such that the tickets may be redeemable directly from the buyer's electronic device.

Typically, a buyer must select one or more seats when purchasing event tickets. However, when a multitude of tickets for a particular event are available for purchase, it can be difficult for a buyer to know which seats are the best quality seats. When purchasing tickets from a secondary ticket marketplace, where sellers freely choose the listing price that they are willing to accept for the ticket(s) they are selling, it also can be difficult for a buyer to determine whether the price of a ticket represents a good value for its seat. Attempts have been made to aid ticket-requesting buyers in determining the quality of seats and/or the price value of tickets. However, these attempts have fallen short and are susceptible to providing buyers with misleading information regarding the quality and/or value of seats. For instance, many attempts to aid ticket-requesting buyers rely solely on market data, that is, data regarding past trades and orders for tickets. This market-only driven approach can result in determined seat qualities and/or values that intuitively are not accurate. For instance, one area of seats to the right of home plate at a Major League Baseball event venue would intuitively have a similar quality as the same area of seats to the left of home plate for the same event. However, if there are season ticket holders that frequently resell their tickets on the right and season ticket holders that rarely resell their tickets on the left, the number of data points and the price points available in the market data can vary dramatically between the two areas, which may lead to an inconsistent discrepancy between the two areas when measuring the value and/or quality of the seats.

Additionally, even though event venue maps often are provided to a ticket-requesting buyer to aid them in determining which seats they'd like to purchase, it can be difficult for the buyer to determine if seats in one area of an event venue map should appropriately be priced higher than seats in another area and, if so, how much more.

The subject disclosure provides for systems and methods for determining the quality of seats and/or the value of prices for tickets for seats for events at event venues. Data related to past transactions for tickets and event venue information (e.g., locations of zones, sections, rows, seats, and the like) may be used to train a machine-learning model to determine a seat desirability score for each seat in an event venue. The trained machine-learning model may be used to determine the best quality seats (i.e., those having the strongest seat desirability score against the appropriate desirability scale) that are available for future events at the event venue. The seat desirability score and a ticket price associated with available ticket listings for future events may be used to determine a pricing value for seats in the event venue. The seat desirability score and/or pricing value may be utilized to guide buyers in selecting desired seats for the future events. The seat desirability score and/or pricing value also may be utilized to guide prospective ticket sellers in setting a price for their available event tickets.

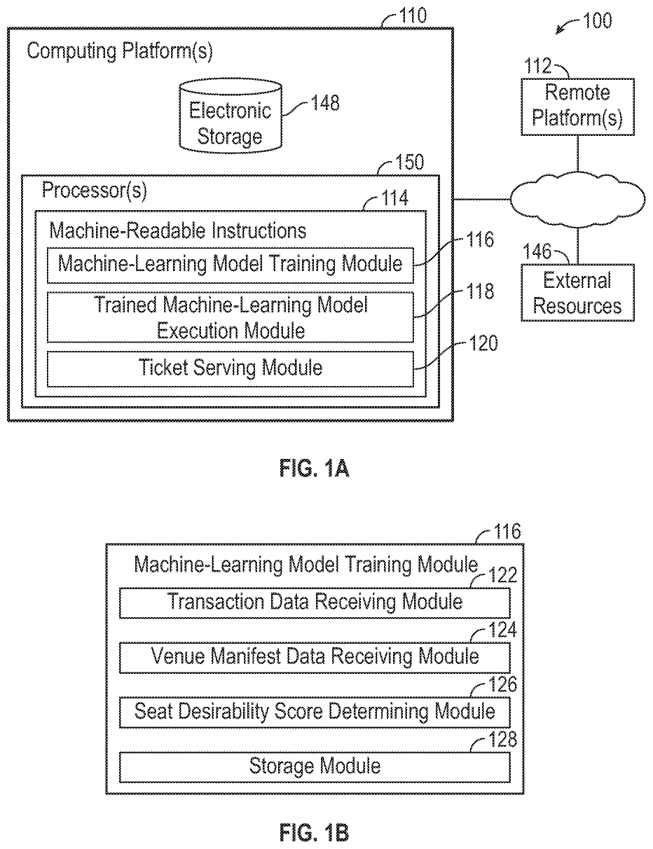

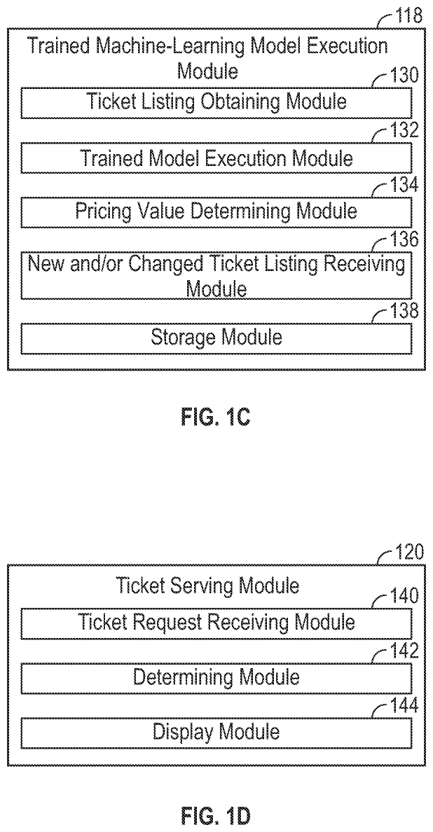

FIGS. 1A-1D illustrate a system configured for determining the quality of seats and/or the value of prices for tickets for seats for events at event venues, according to certain aspects of the disclosure. In some implementations, the system may include one or more computing platforms 110. Computing platform(s) 110 may be configured to communicate with one or more remote platforms 112 according to a client/server architecture, a peer-to-peer architecture, and/or other architectures. Remote platform(s) 112 may be configured to communicate with other remote platforms via computing platform(s) 110 and/or according to a client/server architecture, a peer-to-peer architecture, and/or other architectures. Users may access the system via remote platform(s) 112.

Computing platform(s) 110 may be configured by machine-readable instructions 114. Machine-readable instructions 114 may include one or more instruction modules. The instruction modules may include computer program modules. The instruction modules may include one or more of: machine-learning (“ML”) model training module 116, trained ML model execution module 118, ticket serving module 120, and/or other instruction modules.

Machine-learning model training module 116 may be configured to obtain a trained machine-learning model which may be used to determine a seat desirability score for a plurality of seats at an event venue. In some aspects, and as shown in FIG. 1B, ML model training module 116 includes transaction data receiving module 122, event venue manifest data receiving module 124, seat desirability score determining module 126, storage module 128, and/or other instruction modules.

Transaction data receiving module 122 may be configured to receive transaction data pertaining to a plurality of past ticket transactions, at least a portion of the past ticket transactions being associated with a seat for an event in an event venue. In some aspects, transaction data receiving module 122 may be configured to receive transaction data for a plurality of events that have previously taken place at a plurality of event venues. In some aspects, transaction data for one or more event venues may be stored in the form of a table.

Machine-learning model training module 116 may be configured to operate (i.e., to receive data and determine seat desirability scores) over each one of a plurality of event venue configurations separately, where an event venue configuration may constitute a unique arrangement of seats within a venue. As such, the transaction data receiving module 122 may be configured to receive an identifier of an event venue configuration. In some aspects, an event venue configuration may be event-specific and event venue configurations may vary among different events that have occurred, are occurring, and/or will occur at the event venue. By way of non-limiting example, a single event venue typically may be used for a particular type of sporting event (e.g., football games), but occasionally used for concerts. When an event at the event venue is a concert, the event venue configuration may be different than for the particular type of sporting event, for instance, a stage may be located at one end of the football field such that some sections may not be utilized for the concert event due to being located behind the stage or at such an angle relative to the stage that the concert cannot be adequately enjoyed.

In some aspects, the transaction data may include a type of event associated with an event at an event venue. By way of non-limiting example, types of events may include concerts, sporting events, theatrical performances, and the like. Generally, particular venue configurations may be associated with particular types of events. However, some venue configurations may be used for more than one type of event. Having knowledge of the type of event permits the ML model training module 216 to set a scale such that the range of ticket prices for a particular event may be loosely predictable.

In some aspects, the transaction data for an event venue may include information about where the seats of an historical ticket sale were logically situated within an event venue. By way of non-limiting example, the transaction data may contain, for each historical ticket, a seat number or label, a row number or label, a section number or label, and a zone number or label. By way of non-limiting example, a row may represent a collection of seats, a section may represent a collection of rows and seats, and a zone may represent a collection of sections, rows, and seats. In some aspects, this data may be used by the ML model training module 216 to determine the relation between the desirability of seats in the same or neighboring zones, sections, or rows. By way of non-limiting example, seats within the same row may be assigned similar or identical desirability values.

In some aspects, the transaction data for an event venue may include, or be used to determine, an order of rows of seats. In some aspects, the order of rows may identify the rank of a row within a section of rows and seats, within an event venue to which a specific transaction relates. By way of non-limiting example, row 1 may be the front row of seats within a section of seats within an event venue, row 2 may be the second row of seats (relative to the front) within a section of seats within an event venue, etc.

In some aspects, the transaction data may include an identifier of an event. In some aspects, the event identifier may identify a specific event to which a given transaction relates. Such information may be useful for the normalization of prices, as more fully described below. In some aspects, the transaction data may include an event date. In some aspects, the event date may identify a date of a specific event to which a given transaction relates.

In some aspects, the transaction data may include a ticket price. In some aspects, the ticket price may include the price of one ticket included in a given transaction. By way of a non-limiting example, if a transaction was for two tickets at a cost of $40, the ticket price would be $20.

In some aspects, the transaction data may include an angle of a seat from a point of interest. In some aspects, a specific event may include a main point of interest (“POI”), that is, a main location within an event venue at which the specific event is being held where most spectators desire to look during the specific event. By way of a non-limiting example, when an event is a football game, most spectators desire to look at center field. Thus, in that instance, the POI may be the center of the 50-yard line. By way of a non-limiting example, when an event is a concert, most spectators desire to look at the stage. Thus, in that instance, the POI may be the center of the front of the stage. In some aspects, the angle from the point of interest may be calculated by identifying the angle (e.g., in radians, degrees, or the like) from the POI to a point at or near a seat to which a specific transaction relates. By way of a non-limiting example, a point at or near a seat to which a specific transaction relates may be a center point of a section of seats, a center point of a row within a section, a center point of a particular seat, or the like. In some aspects where a particular section includes a standard geometry, a point at or near a seat to which a specific transaction relates may be calculated utilizing typical geometric equations known to those ordinarily skilled in the art that apply to the standard geometric shape. In some aspects where a particular section includes a less-standard geometry, the boundaries of a section of seats may be designed in a vector graphics format such that a polygon may be formed for the section of seats. In such instances, the center of the polygon may be determined, utilizing typical geometric equations known to those ordinarily skilled in the art, and utilized as the center point of the section of seats. In some aspects, the angle from the point of interest for a particular seat in a section of seats may be defined as the angle from the point of interest for each seat in the section of seats.

In some aspects, the transaction data may include a distance from a point of interest. In some aspects, the distance from the point of interest may identify the distance (for instance, in pixels on an electronic venue map) from the POI to a point at or near a seat to which a specific transaction relates. By way of a non-limiting example, a point at or near a seat to which a specific transaction relates may be a center point of a section of seats, a center point of a row within a section, a center point of a particular seat, or the like. In some aspects where a particular section includes a standard geometry, a center point of a section of seats may be calculated utilizing typical geometric equations known to those ordinarily skilled in the art that apply to the standard geometric shape. In some aspects where a particular section includes a less-standard geometry, the boundaries of a section of seats may be designed in a vector graphics format such that a polygon may be formed for the section of seats. In such instances, the center of the polygon may be determined, utilizing typical geometric equations known to those ordinarily skilled in the art, and utilized as the point at or near the seat to which a specific transaction relates.

In some aspects, the transaction data may include a time until a specific event is set to occur. In some aspects, the time until a specific event is set to occur may identify how much time (e.g., in hours) before a specific event the ticket(s) included in a given transaction were sold. In some aspects, the actual time until a specific event is set to occur may be used to train the machine-learning model while a fixed time until event occurrence, e.g., 48 hours, may be utilized upon execution of a trained ML model (e.g., the trained ML model execution module 218, as more fully described below) to obtain seat desirability score(s) for ticket(s) for a future event.

Event venue manifest data receiving module 124 may be configured to receive event venue manifest data for a plurality of venues for which a ticket server (e.g., ticket serving module 120) is configured to serve tickets to buyers. In some aspects, the event venue manifest data may include an identifier of a venue configuration for an event. In some aspects, the identifier of the event venue configuration may identify the venue configuration. In some aspects, the venue configuration may vary among different events that have occurred, are occurring, and/or will occur at the venue. By way of non-limiting example, a single venue typically may be used for a particular type of sporting event (e.g., football games), but occasionally used for concerts. When an event at the event venue is a concert, the venue configuration may be different than for the particular type of sporting event, for instance, a stage may be located at one end of the football field such that some sections may not be utilized for the concert event due to being located behind the stage or at such an angle relative to the stage that the concert cannot be adequately enjoyed.

In some aspects, the event venue manifest data for a particular event venue may include a type of events associated with an event at that particular event venue. By way of non-limiting example, types of events may include concerts, sporting events, theater performances, and the like. Generally, specific event venue configurations for a particular event venue may be associated with one or more types of events. Having knowledge of the type of event at a particular event venue permits the ML model training module 216 to set a scale such that the range of ticket prices for a particular event at a particular venue may be loosely predictable.

In some aspects, the event venue manifest data for a particular event venue may include information about where the seats of a ticket sale are logically situated within an event venue. By way of non-limiting example, the event venue manifest data may contain, for each ticket, a seat number or label, a row number or label, a section number or label, and a zone number or label. By way of a non-limiting example, a row may represent a collection of seats, a section may represent a collection of rows and seats, and a zone may represent a collection of sections, rows, and seats. In some aspects, this data may be used by the ML model training module 216 to determine the relation between the desirability of seats in the same or neighboring zones, sections, or rows. By way of non-limiting example, seats within the same row may be assigned similar or identical desirability values. In some aspects, the event venue manifest data for a particular event venue may include, or be used to determine, an order of rows. In some aspects, the order of rows may identify the rank of a row within an order of rows of seats, within a section of seats, within an event venue to which a specific transaction relates. By way of non-limiting example, row 1 may be the front row of seats within a section of seats within a particular event venue, row 2 may be the second row of seats (relative to the front) within a section of seats within a particular event venue, etc.

In some aspects, the event venue manifest data for a particular event venue may include angles from a point of interest. Generally, a specific event may include a main point of interest (“POI”), that is, a main location within a particular event venue in which the specific event is being held where most spectators desire to look during the specific event. By way of non-limiting example, when an event is a football game, most spectators desire to look at center field. Thus, in that instance, the POI may be the center of the 50-yard line. By way of non-limiting example, when an event is a concert, most spectators desire to look at the stage. Thus, in that instance, the POI may be the stage. In some aspects, the angle from the point of interest may be calculated by identifying the angle (e.g., in radians, degrees, or the like) from the POI to a point at or near a seat to which a specific transaction relates. By way of non-limiting example, a point at or near a seat to which a specific transaction relates may be a center point of a section of seats, a center point of a row within a section, a center point of a particular seat, or the like. In some aspects where a particular section includes a standard geometry, a point at or near a seat to which a specific transaction relates may be calculated utilizing typical geometric equations known to those ordinarily skilled in the art that apply to the standard geometric shape. In some aspects where a particular section includes a less-standard geometry, the boundaries of a section of seats may be designed in a vector graphics format such that a polygon may be formed for the section of seats. In such instances, the center of the polygon may be determined, utilizing typical geometric equations known to those ordinarily skilled in the art, and utilized as the center point of the section of seats. In some aspects, the angle from the point of interest for a particular seat in a section of seats may be defined as the angle from the point of interest for each seat in the section of seats.

In some aspects, the event venue manifest data for a particular event venue may include distances from a point of interest. In some aspects, a distance from the point of interest may be the distance (e.g., in pixels on a venue map) from the POI to a point at or near a seat to which a specific transaction relates. In some aspects where a particular section includes a standard geometry, a point at or near a seat to which a specific transaction relates may be calculated utilizing typical geometric equations known to those ordinarily skilled in the art that apply to the standard geometric shape. In some aspects where a particular section includes a less-standard geometry, the boundaries of a section of seats may be designed in a vector graphics format such that a polygon may be formed for the section of seats. In such instances, the center of the polygon may be determined, utilizing typical geometric equations known to those ordinarily skilled in the art, and utilized as the point at or near a seat to which a specific transaction relates. In some aspects, the distance from a point of interest for a particular seat in a section of seats may be defined as the distance from the point of interest for each seat in the section of seats.

Seat desirability score determining module 126 may be configured to determine a seat desirability score for one or more seats at an event venue for a particular event and/or event venue configuration. In some aspects, upon receipt of the transaction data (by the transaction data receiving module 122) and the event venue manifest data (by the event venue manifest data receiving module 124), the seat desirability score determining module 126 may be configured to determine whether the transaction and event venue manifest data passes certain modeling criteria. By way of non-limiting example, these modeling criteria may be applied to transaction and event venue manifest data for a particular event venue/type-of-event combination. In some aspects, if the modeling criteria are not met, the data or portions of the data may be assumed to be insufficient or not of high enough quality to provide an adequate determination of seat quality or desirability for future listings. By way of non-limiting example, the modeling criteria may include determining whether the number of data points in the transaction and/or event venue manifest data exceeds a specified threshold value dependent on the venue/type-of-event combination. By way of non-limiting example, the modeling criteria may include determining whether an average number of transactions per event exceeds a specified threshold value dependent on the venue/type-of-event combination. In such examples, the average number of transactions per event may be calculated as {# of transactions for the particular venue/type-of-event combination}/{# of discrete events in the transaction and/or event venue manifest data}. By way of non-limiting example, the modeling criteria may include determining whether the average number of transactions per section of seats in the transaction and/or event venue manifest data exceeds a threshold value dependent on the venue/type-of-event combination. In such examples, the average number of transactions per section of seats may be calculated as {# of transactions for a particular venue/type-of-event combination}/{# of discrete sections in the event venue}.

In some aspects, the seat desirability score determining module 126 may be configured to remove duplicate entries from the transaction data and the event venue manifest data.

In some aspects, the seat desirability score determining module 126 may be configured to impute missing values. By way of a non-limiting example, the median value of continuous features, i.e., row order, angle from main point of interest, distance from main point of interest and time to event, may be used in place of missing values. In some aspects, the median values may be collected from the transaction data and used to impute both the transaction data and the event venue manifest data.

In some aspects, the seat desirability score determining module 126 may be configured to impute missing values for non-continuous features, such as the zone number or label. By way of a non-limiting example, the most common value of a non-continuous feature may be used in place of missing values. By way of a non-limiting example, if there is a tie for the most common value, an arbitrary value between the tied values may be selected. In some aspects, the most common value may be collected from the transaction data, and then used to impute both the transaction data and the event venue manifest data.

In some aspects, the seat desirability score determining module 126 may be configured to remove outliers from the transaction data. By way of a non-limiting example, outliers may be removed by removing values exceeding three standard deviations from the mean of a continuous feature, such as row order, angle from main point of interest, distance from main point of interest, or time-to-event.

In certain aspects of the present disclosure, ticket price may be used as a proxy for seat quality. (It will be understood by those having ordinary skill in the art that embodiments hereof are not limited to ticket price as a proxy and that other proxy values, e.g., ratings, may be used.) In some aspects, the following procedure may be applied, by the seat desirability score determining module 126, to transform the ticket price in the transaction data such that transformed ticket prices can be compared in a meaningful way across different events and different event venues.

First, a median ticket price may be calculated. In some aspects, the median ticket price may be calculated as the median ticket price for all tickets sold in the transaction data for the particular event venue/type-of-event combination. Second, a median event ticket price may be calculated. In some aspects, the median event ticket price may be calculated as the median ticket price for all tickets sold in the transaction data for a particular event. Third, a normalized ticket price may be calculated. In some aspects, the normalized ticket price may be calculated by dividing the ticket price in the transaction data by the median event ticket price, and multiplying it by the median ticket price. Fourth, a log of the normalized ticket price may be calculated. In some aspects, the logarithm of the normalized ticket price may be calculated by applying the natural logarithm to the normalized ticket price. The logarithm of the normalized ticket price may be utilized as the response variable of a machine-learning model, as described herein below.

In some aspects, the seat desirability score determining module 126 may be configured to calculate the natural logarithm of the distance from the main point of interest, such that distances in different sized event venues may be compared in a meaningful way. This logarithm of the distance from the main point of interest may be added to the transaction data and the event venue manifest data.

In some aspects, the seat desirability score determining module 126 may encode (for instance, using one-hot encoding, label encoding, binary encoding, or the like) categorical features such as the zone number or label in both the event venue manifest data and the transaction data. In some aspects, this may allow the seat desirability score determining module 126 to determine appropriately similar seat desirability scores for seats in the same category, such as seats in the same zone.

In some aspects, the seat desirability score determining module 126 may apply a discretization procedure to one or more of the continuous features, such as distance from the main point of interest, angle from the main point of interest, and time-to-event features independently. By way of a non-limiting example, the discretization procedure may be applied as follows:

First, the data may be partitioned into a number of categories, i.e., 5 categories, based on equal quantiles, e.g., values up to the 0.2-th quantile are given label 1, values between the 0.2th and 0.4th quantile are given label 2, etc. Second, the new quantiles may be encoded (for instance, using one-hot encoding, label encoding, binary encoding, or the like) and the new features may be added to the transaction data and the event venue manifest data. In some aspects, the specific partitioning and encoding may be determined using the transaction data, and applied to both the transaction data and the event venue manifest data. In some aspects, these discretization procedures may allow the seat desirability score determining module 126 to determine appropriately similar seat desirability scores for seats with similar, but not identical, distances from the main point of interest, angles from the main point of interest, and time-to-event values.

In some aspects, the seat desirability score determining module 126 may incorporate features that combine the categorical and continuous features. By way of non-limiting example, the following procedure may be applied using the zone number or label as the categorical feature and the time-to-event, angle from main point of interest, and distance from main point of interest as the continuous features: First, for each transaction, all transactions having the same zone number or label may be collected. Second, the average value of each continuous feature (time-to-event, angle from main point of interest, and distance from main point of interest) in that zone number or label may be calculated. Third, those average values of time-to-event, angle from main point of interest, and distance from main point of interest within that particular zone number or label may be added to the data as new features. By way of a non-limiting example, this same procedure may be applied to incorporate feature(s) that combine categorical features with the response variable, i.e., including the average value of the response variable within each zone number or label as a new feature. In some aspects, this may allow the seat desirability score determining module 126 to determine appropriately similar seat desirability scores for seats in the same category, such as seats in the same zone number or label, and further may allow the seat desirability score determining module 126 to determine appropriately distinct seat desirability scores for seats in different categories, such as seats in different zone numbers or labels.

In some aspects, the seat desirability score determining module 126 may be configured to scale the continuous features (i.e., time-to-event, angle from main point of interest, distance from main point of interest, logarithm of distance from main point of interest, binned time-to-event, and binned angle from main point of interest) by applying min-max normalization as follows: First, the minimum (“min”) and maximum (“max”) of a continuous feature may be calculated from the transaction data (i.e. time-to-event, angle from main point of interest, and distance from main point of interest). Second, each value of the continuous feature (“original_value”) may be replaced with a new value calculated as {original_value−min}/{max−min} in both the transaction data and the event venue manifest data. It will be understood by those having ordinary skill in the art that min-max normalization is described here by way of example and not limitation and that utilization of other normalization techniques is within the scope of embodiments of the present disclosure.

In some aspects, the seat desirability score determining module 126 may be configured to train/fit a machine-learning model to the transaction data, with the logarithm of the normalized ticket price as the response variable and both transaction related and event venue related features as predictors (i.e., time-to-event, angle from main point of interest, distance from main point of interest, logarithm of distance from main point of interest, binned time-to-event, binned angle from main point of interest, binned distance from main point of interest, and encoded zone number of label). By way of non-limiting example, a gradient boosting regression model may be used. By way of example and not limitation, the machine-learning model may be a gradient boosting regression model that may be trained using the following hyper parameters: (i) the loss function as squared error; (ii) the maximum depth of the boosting trees as 3; (iii) the sub-sample ratio of the training instance for the boosting trees as 0.5.

In some aspects, the seat desirability score determining module 126 may be configured to apply the trained machine-learning model to either event venue manifest data or to the transaction data, to generate a seat desirability score for the seats relevant to each record in the data. In some aspects, the seat desirability score of each seat in an event venue may be used in ranking the quality of seats relative to one another.

In some aspects, the seat desirability score determining module 126 may be configured to apply a correlation test, e.g., a Pearson correlation test, to determine if the seat desirability scores for each venue/type-of-event combination are good enough to be used in production. By way of example and not limitation, the following process may be used: First, the transactions may be ranked by seat desirability score. Second, the transactions may be ranked by ticket price. Third, the Pearson Correlation Coefficient between the ranked seat desirability scores and the ranked ticket prices may be calculated. In some aspects, if the Pearson Correlation Coefficient meets a threshold value specific to the venue/type-of-event combination, it may be deemed to pass the test and the online ranking tool may be used for this venue configuration/type-of-event using the calculated values. In some aspects, if the test is not passed, this venue configuration/type-of-event combination may not be turned on.

Storage module 128 may be configured to store the seat desirability score in association with the event venue manifest data and the transaction data.

The trained machine-learning model execution module 118 may be configured to execute the trained ML model on a plurality of listings for tickets to obtain a seat desirability score for seats associated with ticket listings included in the plurality of listings for tickets. In some aspects, and as shown in FIG. 1C, trained ML model execution module 118 may include one or more of ticket listing obtaining module 130, trained model execution module 132, pricing value determining module 134, new and/or changed ticket listing receiving module 136, and storage module 138, and/or other instruction modules.

Ticket listing obtaining module 130 may be configured to obtain, from a ticket server (e.g., ticket serving module 120), a plurality of listings for tickets for events at event venues, the plurality of listings for tickets being capable of being served to buyers and/or prospective buyers. In some aspects, each of the plurality of listings for tickets may include an event identifier identifying a type-of-event pertaining to each ticket listing, a seat identifier identifying a seat associated with each ticket listing, and a ticket price for each seat included in each ticket listing.

Trained ML model execution module 132 may be configured to execute the trained ML model obtained from the machine-learning model training module 116 for one or more of the ticket listings obtained by the ticket listing obtaining module 130.

Pricing value determining module 134 may be configured to determine a pricing value for one or more seats associated with ticket listings received by the ticket listing obtaining module 130 and trained by the trained ML model execution module 132. For instance, a pricing value may be calculated as a function of the seat desirability score, the ticket price and/or other factors. For example, if the ML model is trained to predict ticket prices, a price value may be determined by dividing the seat desirability score by the ticket price. In another example, if the ML model is trained to predict log-transformed ticket prices, the price value may be determined by subtracting the log-transformed price from the seat desirability score.

New and/or changed ticket listing receiving module 136 may be configured to receive new ticket listings and/or ticket listings for which a change in price has been detected. Upon receipt of a new or changed ticket listing by the new and/or changed ticket listing receiving module 136, the trained ML model execution module 132 may be configured to execute the trained ML model for each new and/or changed ticket listing.

Storage module 138 may be configured to store each ticket listing of the plurality of listings for tickets with the seat desirability score and pricing value for each seat associated therewith in an electronic inventory catalog in the form of a lookup table.

Ticket serving module 120 may be configured to receive requests for tickets and serve ticket-requesting buyers with at least one of a ticket for the best value seat (determined as a ticket having the strongest pricing value) or a ticket for best quality seat (determined as a ticket having the strongest seat desirability score). In some aspects, and as shown in FIG. 1D, ticket serving module 120 may include ticket request receiving module 140, determining module 142, display module 144, and/or other instruction modules.

Ticket request receiving module 140 may be configured to receive one or more requests for tickets for a particular event, at a particular event venue, at a particular date/time. In some aspects, a received ticket request may include a request for a best quality seat or a best value seat. Determining module 142 may be configured to query the electronic inventory catalog lookup table to determine one of a best value seat or a best quality seat, as appropriate. Display module 144 may be configured to cause display of at least one ticket option for a best value seat or at least one ticket option for a best quality seat, as appropriate. In some aspects, a ranked listing of a plurality of ticket options may be displayed.

With reference back to FIG. 1A, in some implementations, computing platform(s) 110, remote platform(s) 112, and/or external resources 146 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 110, remote platform(s) 112, and/or external resources 146 may be operatively linked via some other communication media.

A given remote platform 112 may include one or more processors configured to execute computer program modules. The computer program modules may be configured to enable an expert or user associated with the given remote platform 112 to interface with system 100 and/or external resources 146, and/or provide other functionality attributed herein to remote platform(s) 112. By way of non-limiting example, a given remote platform 112 and/or a given computing platform 110 may include one or more of a server, a desktop computer, a laptop computer, a handheld computer, a tablet computing platform, a NetBook, a Smartphone, a gaming console, and/or other computing platforms.

External resources 146 may include sources of information outside of system 100, external entities participating with system 100, and/or other resources. In some implementations, some or all of the functionality attributed herein to external resources 146 may be provided by resources included in system 100.

Computing platform(s) 110 may include electronic storage 148, one or more processors 150, and/or other components. Computing platform(s) 110 may include communication lines, or ports to enable the exchange of information with a network and/or other computing platforms. Illustration of computing platform(s) 110 in FIG. 1A is not intended to be limiting. Computing platform(s) 110 may include a plurality of hardware, software, and/or firmware components operating together to provide the functionality attributed herein to computing platform(s) 110. For example, computing platform(s) 110 may be implemented by a cloud of computing platforms operating together as computing platform(s) 110.

Electronic storage 148 may comprise non-transitory storage media that electronically stores information. The electronic storage media of electronic storage 148 may include one or both of system storage that is provided integrally (i.e., substantially non-removable) with computing platform(s) 110 and/or removable storage that is removably connectable to computing platform(s) 110 via, for example, a port (e.g., a USB port, a firewire port, etc.) or a drive (e.g., a disk drive, etc.). Electronic storage 148 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 148 may include one or more virtual storage resources (e.g., cloud storage, a virtual private network, and/or other virtual storage resources). Electronic storage 148 may store software algorithms, information determined by processor(s) 150, information received from computing platform(s) 110, information received from remote platform(s) 112, and/or other information that enables computing platform(s) 110 to function as described herein.

Processor(s) 150 may be configured to provide information processing capabilities in computing platform(s) 110. As such, processor(s) 150 may include one or more of a digital processor, an analog processor, a digital circuit designed to process information, an analog circuit designed to process information, a state machine, and/or other mechanisms for electronically processing information. Although processor(s) 150 is shown in FIG. 1 as a single entity, this is for illustrative purposes only. In some implementations, processor(s) 150 may include a plurality of processing units. These processing units may be physically located within the same device, or processor(s) 150 may represent processing functionality of a plurality of devices operating in coordination. Processor(s) 150 may be configured to execute modules 116, 118, 120, 122, 124, 126, 128, 130, 132, 134, 136, 138, 140, 142, and/or 144, and/or other modules. Processor(s) 150 may be configured to execute modules 116, 118, 120, 122, 124, 126, 128, 130, 132, 134, 136, 138, 140, 142, and/or 144, and/or other modules by software; hardware; firmware; some combination of software, hardware, and/or firmware; and/or other mechanisms for configuring processing capabilities on processor(s) 150. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 116, 118, 120, 122, 124, 126, 128, 130, 132, 134, 136, 138, 140, 142, and/or 144 are illustrated in FIG. 1 as being implemented within a single processing unit, in implementations in which processor(s) 150 includes multiple processing units, one or more of modules 116, 118, 120, 122, 124, 126, 128, 130, 132, 134, 136, 138, 140, 142, and/or 144 may be implemented remotely from the other modules. The description of the functionality provided by the different modules 116, 118, 120, 122, 124, 126, 128, 130, 132, 134, 136, 138, 140, 142, and/or 144 described below is for illustrative purposes, and is not intended to be limiting, as any of modules 116, 118, 120, 122, 124, 126, 128, 130, 132, 134, 136, 138, 140, 142, and/or 144 may provide more or less functionality than is described. For example, one or more of modules 116, 118, 120, 122, 124, 126, 128, 130, 132, 134, 136, 138, 140, 142, and/or 144 may be eliminated, and some or all of its functionality may be provided by other ones of modules 116, 118, 120, 122, 124, 126, 128, 130, 132, 134, 136, 138, 140, 142, and/or 144. As another example, processor(s) 150 may be configured to execute one or more additional modules that may perform some or all of the functionality attributed below to one of modules 116, 118, 120, 122, 124, 126, 128, 130, 132, 134, 136, 138, 140, 142, and/or 144.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

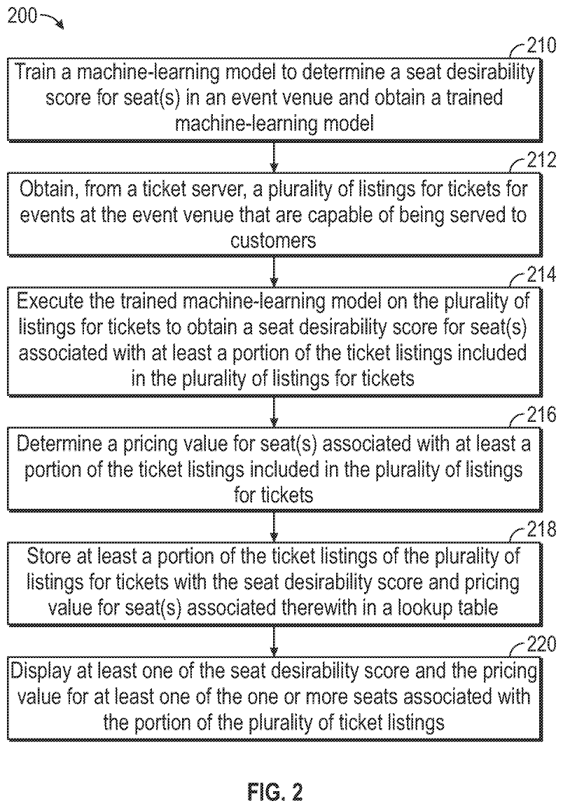

FIG. 2 illustrates an exemplary flow diagram (e.g., process 200) for determining the quality of seats and/or the value of prices for tickets for seats for events at event venues, according to certain aspects of the disclosure. For explanatory purposes, the exemplary process 200 is described herein with reference to FIGS. 1A, 1B, 1C and 1D. Further for explanatory purposes, the steps of the example process 200 are described herein as occurring in serial, or linearly. However, multiple instances of the exemplary process 200 may occur in parallel.

At step 210, the process 200 may include training a machine-learning model to determine a seat desirability score for a plurality of seats at an event venue and obtain a trained machine-learning model. The machine-learning model may be trained using transaction data pertaining to a plurality of past ticket transactions. In some aspects, each past ticket transaction of the plurality of past ticket transactions may be associated with a seat for an event at the event venue. In some aspects, the transaction data may include a type of event associated with each past ticket transaction of the plurality of past ticket transactions. In some aspects, the transaction data may include a venue seat configuration for the event associated with one or more past ticket transactions of the plurality of past ticket transactions. In some aspects, the transaction data may include a seat identifier identifying a seat associated with one or more past ticket transactions of the plurality of past ticket transactions.

The machine-learning model further may be trained using event venue manifest data. In some aspects, the event venue manifest data may include a type of event for each event associated with the venue. In some aspects, the event venue manifest data may include a venue seat configuration associated with one or more types of events. In some aspects, the event venue manifest data may include a venue seat configuration associated with a particular event. In some aspects, the venue seat configuration may include a seat identifier for at least a portion of the seats at the event venue, a seat location for at least the portion of the seats at the event venue, and a point of interest.

At step 212, the method may include obtaining, from a ticket server, a plurality of listings for tickets for events at the event venue, the plurality of listings for tickets being capable of being served to buyers. In some aspects, one or more of the plurality of listings for tickets may include an event identifier identifying a type of event pertaining to each ticket listing. In some aspects, one or more of the plurality of listings for tickets may include a seat identifier identifying a seat associated with each ticket listing. In some aspects, one or more of the plurality of listings for tickets may include a ticket price for at least one seat included in the one or more ticket listings.

At step 214, the method may include executing the trained machine-learning model on the plurality of listings for tickets to obtain a seat desirability score for one or more seats associated with at least a portion of the listings included in the plurality of listings for tickets.

At step 216, the method may include determining a pricing value for one or more seats associated with at least a portion of the listings included in the plurality of listings for tickets.

At step 218, the method may include storing at least a portion of the ticket listings of the plurality of listings for tickets with the seat desirability score and pricing value for one or more seats associated therewith in a lookup table, for instance, of an electronic inventory catalog. In some aspects, the lookup table may be used to determine the best quality seats available for an event (i.e., those having the strongest seat desirability score with respect to the seat desirability scale utilized), the best value seats available for an event (i.e., those having the strongest pricing value with respect to the pricing value scale utilized), and/or to guide a ticket seller in pricing one or more tickets that s/he has available to sell (e.g., using the seat desirability score).

At step 220, the method may include causing display of at least one of the seat desirability score and the pricing value for at least one of the one or more seats associated with the portion of the plurality of ticket listings.

For example, as described above in relation to FIGS. 1A-1D, at step 210, the process 200 may include training a machine-learning model to determine a seat desirability score for one or more seats at a plurality of event venues and obtain a trained machine-learning model (e.g., through machine-learning training module 116 of FIGS. 1A and 1B). At step 212, the process 200 may include obtaining, from a ticket server, a plurality of listings for tickets for events at the plurality of event venues that are capable of being served to buyers (e.g., through ticket listing obtaining module 130 of the trained machine-learning execution module 118 of FIGS. 1A and 1C). At step 214, the method may include executing the trained machine-learning model on the plurality of listings for tickets to obtain a seat desirability score for at least a portion of the seats associated with one or more ticket listings included in the plurality of listings for tickets (e.g., through trained machine-learning model execution module 132 of the trained machine-learning model execution module 118 of FIGS. 1A and 1C). At step 216, the method may include determining a pricing value for one or more seats associated with at least a portion of the ticket listings included in the plurality of listings for tickets (e.g., through the pricing value determining module 134 of the trained machine-learning model execution module 118 of FIGS. 1A and 1C). At step 218, the method may include storing at least a portion of the ticket listings of the plurality of listings for tickets with the seat desirability score and the pricing value for the seat(s) associated therewith in a lookup table (e.g., through the storage module 138 of the trained machine-learning execution module 118 of FIGS. 1A and 1C). At step 220, the method may include causing display of at least one of the seat desirability score and the pricing value for at least one of the one or more seats associated with the portion of the plurality of ticket listings (e.g., through the display module 144 of the ticket serving module 120 of FIG. 1D).

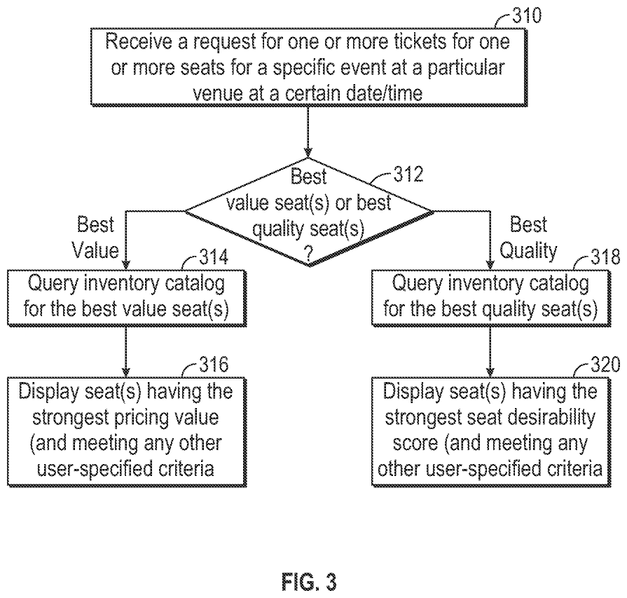

FIG. 3 illustrates an exemplary flow diagram (e.g., process 300) for serving tickets for at least one of the best quality seat and/or the best value seat at an event venue according to certain aspects of the disclosure. For explanatory purposes, the exemplary process 300 is described herein with reference to FIGS. 1A-1D. Further for explanatory purposes, the steps of the exemplary process 300 are described herein as occurring in serial, or linearly. However, multiple instances of the exemplary process 300 may occur in parallel.

At step 310, method 300 may include receiving a request for one or more tickets for one or more seats for a specific event at a particular venue at a certain date/time. At step 312, the method 300 may include determining whether the ticket-requesting buyer desires to be shown one or more tickets for the best quality seats available for the event or one or more tickets for the best value seats available for the event. If it is determined at step 312 that the ticket-requesting buyer desires to be shown one or more tickets for the best quality seats available for the event, at step 314, the method may include determining (e.g., by querying a lookup table, for instance, of an electronic inventory catalog) one or more ticket listings having the best seat desirability score (i.e., those having the strongest seat desirability score with respect to the seat desirability scale utilized). At step 316, the one or more ticket listings having the best seat desirability score (and meeting any other buyer-specified criteria) may be caused to be displayed.

If it is determined at step 312 that the ticket-requesting buyer desires to be shown one or more tickets for the best value seats available for the event, at step 318, the method may include determining (e.g., by querying a lookup table, for instance, of an electronic inventory catalog) one or more ticket listings having a best pricing value (i.e., those having the strongest pricing value with respect to the pricing value scale utilized). At step 320, the one or more ticket listings having the best pricing value (and meeting any other buyer-specified criteria) may be caused to display.

For example, as described above in relation to FIGS. 1A-1D, at step 310, the process 300 may include receiving a request for one or more tickets for one or more seats for a specific event at a particular venue at a certain date/time (e.g., through the ticket request receiving module 140 of the ticket serving module 120 of FIG. 1D). At step 312, the method 300 may include determining whether the ticket-requesting buyer desires to be shown one or more tickets for the best quality seats available for the event or one or more tickets for the best value seats available for the event. If it is determined at step 312 that the ticket-requesting buyer desires to be shown one or more tickets for the best quality seats available for the event, at step 314, the method may include determining one or more ticket listings having a best seat desirability score (e.g., through querying module 142 of the ticket serving module 120 of FIG. 1D). At step 316, the one or more ticket listings having the best seat desirability score may be caused to be displayed (e.g., through the display module 144 of the ticket serving module 120 of FIG. 1D). If it is determined at step 312 that the ticket-requesting buyer desires to be shown one or more tickets for the best value seats available for the event, at step 318, the method may include determining one or more ticket listings having a best pricing value (e.g., through querying module 142 of the ticket serving module 120 of FIG. 1D). At step 320, the one or more ticket listings having the best pricing value may be caused to be displayed (e.g., through the display module 144 of the ticket serving module 120 of FIG. 1D).

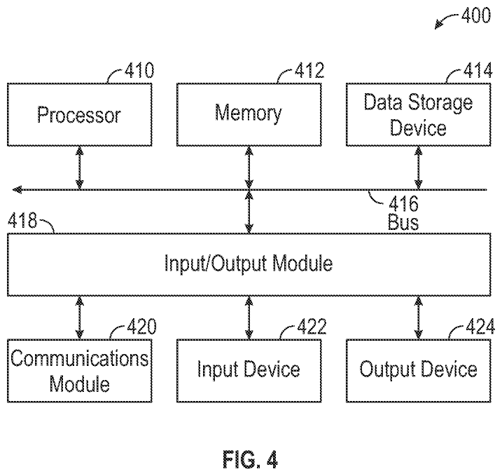

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities.

Computer system 400 (e.g., server and/or client) includes a bus 416 or other communication mechanism for communicating information, and a processor 410 coupled with bus 416 for processing information. By way of example, the computer system 400 may be implemented with one or more processors 410. Processor 410 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 412, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 416 for storing information and instructions to be executed by processor 410. The processor 410 and the memory 412 can be supplemented by, or incorporated in, special purpose logic circuitry.

The instructions may be stored in the memory 412 and implemented in one or more computer program products, i.e., one or more modules of computer program instructions encoded on a computer readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 412 may also be used for storing temporary variable or other intermediate information during execution of instructions to be executed by processor 410.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 414 such as a magnetic disk or optical disk, coupled to bus 416 for storing information and instructions. Computer system 400 may be coupled via input/output module 418 to various devices. The input/output module 418 can be any input/output module. Exemplary input/output modules 418 include data ports such as USB ports. The input/output module 418 is configured to connect to a communications module 420. Exemplary communications modules 420 include networking interface cards, such as Ethernet cards and modems. In certain aspects, the input/output module 418 is configured to connect to a plurality of devices, such as an input device 422 and/or an output device 424. Exemplary input devices 422 include a keyboard and a pointing device, e.g., a mouse or a trackball, by which a user can provide input to the computer system 400. Other kinds of input devices 422 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 424 include display devices such as a LCD (liquid crystal display) monitor, for displaying information to the user.

According to one aspect of the present disclosure, the above-described gaming systems can be implemented using a computer system 400 in response to processor 410 executing one or more sequences of one or more instructions contained in memory 412. Such instructions may be read into memory 412 from another machine-readable medium, such as data storage device 414. Execution of the sequences of instructions contained in the main memory 412 causes processor 410 to perform the process steps described herein. One or more processors in a multi-processing arrangement may also be employed to execute the sequences of instructions contained in memory 412. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 410 for execution. Such a medium may take many forms, including, but not limited to, non-volatile media, volatile media, and transmission media. Non-volatile media include, for example, optical or magnetic disks, such as data storage device 414. Volatile media include dynamic memory, such as memory 412. Transmission media include coaxial cables, copper wire, and fiber optics, including the wires that comprise bus 416. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 400 reads game data and provides a game, information may be read from the game data and stored in a memory device, such as the memory 412. Additionally, data from the memory 412 servers accessed via a network the bus 416, or the data storage 414 may be read and loaded into the memory 412. Although data is described as being found in the memory 412, it will be understood that data does not have to be stored in the memory 412 and may be stored in other memory accessible to the processor 410 or distributed among several media, such as the data storage 414-.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for determining the quality of seats and/or value of prices for seat tickets at event venues, the method comprising:
obtaining, from a ticket server, a plurality of ticket listings for a plurality of events at an event venue, the plurality of tickets listings being capable of being served to buyers, wherein at least a portion of the plurality of ticket listings includes one or more of a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings;
executing a trained machine-learning model on at least the portion of the plurality of ticket listings to obtain a seat desirability score for one or more seats associated with the portion of the plurality of ticket listings;
determining a pricing value for the portion of the plurality of ticket listings; and
causing to display at least one of the seat desirability score and the pricing value for at least one of the one or more seats associated with the portion of the plurality of ticket listings.

2. The computer-implemented method of claim 1, further comprising:
obtaining transaction data pertaining to a plurality of past ticket transactions, at least a portion of the plurality of past ticket transactions being associated with one or more seats for a past event at the event venue, the transaction data including one or more of: a type of event of the past event associated with at least the portion of the plurality of past ticket transactions, a venue seat configuration for the event associated with at least the portion of the plurality of past ticket transactions, and a seat identifier identifying one or more seats associated with at least the portion of the plurality of past ticket transactions;
obtaining event venue manifest data, at least a portion of the event venue manifest data including one or more of: a type of event for each type of event for which an associated event venue is used, and a venue seat configuration associated with at least a portion of the event types, the event venue seat configuration including a seat identifier for at least a portion of the seats at the event venue, a seat location for at least the portion of the seats at the event venue, and a point of interest; and
training a machine-learning model using the transaction data and the event venue manifest data to determine a seat desirability score for a plurality of seats at the event venue and to obtain the trained machine-learning model, the seat desirability score for at least a portion of the plurality of seats at the event venue being dependent upon an event at the event venue, the event being associated with an event venue seat configuration and a type of event.

3. The computer-implemented method of claim 2,
wherein the transaction data includes information related to past ticket transactions associated with a plurality of event venues for which the ticket server is configured to serve tickets to buyers, and
wherein the event venue manifest data includes information related to the plurality of venues for which the ticket server is configured to serve tickets to buyers.

4. The computer-implemented method of claim 1, wherein the seat desirability score is determined for the one or more seats associated with the portion of the plurality of ticket listings by applying the trained machine learning model to the one or more seats.

5. The computer-implemented method of claim 1, further comprising:
receiving a new ticket listing for one or more tickets capable of being served to buyers by the ticket server, the new ticket listing including one or more of: an event venue identifier identifying an event venue pertaining to the new ticket listing, a type of event pertaining to the new ticket listing, a seat identifier identifying a seat associated with the new ticket listing, and a price for the seat associated with the new ticket listing;
executing the trained machine-learning model on the new ticket listing to obtain a seat desirability score for the seat associated with the new ticket listing;
determining a pricing value for the seat associated with the new ticket listing; and
storing the new ticket listing with the seat desirability score and pricing value for the seat associated therewith.

6. The computer-implemented method of claim 1, further comprising:
receiving a request for a ticket for a seat having a strong seat desirability score for an event at the event venue;
determining one or more ticket listings of the plurality of ticket listings having the strong seat desirability score; and
causing display of at least one of the one or more ticket listings.

7. The computer-implemented method of claim 1, further comprising:
receiving a request for a ticket for a seat having a strong pricing value for an event at the venue;
determining one or more ticket listings of the plurality of ticket listings having the strong pricing value; and
causing display of at least one of the one or more ticket listings.

8. The computer-implemented method of claim 2, wherein the transaction data pertaining to the plurality of past ticket transactions and the event venue manifest data further include: a zone identifier identifying a zone within the event venue associated with at least the portion of the past ticket transactions of the plurality of past ticket transactions; a section identifier identifying a section within the event venue associated with at least the portion of the past ticket transactions of the plurality of past ticket transactions; and a row within the event venue associated with at least the portion of the past ticket transactions of the plurality of past ticket transactions.

9. The computer-implemented method of claim 8,
wherein the point of interest included in the event venue manifest data includes an event-type point of interest associated with each type of event associated with at least the portion of the past ticket transactions of the plurality of past ticket transactions, and
wherein the seat location included in the event venue manifest data includes information associated with each seat, row and/or section within the event venue associated with at least the portion of the past ticket transactions of the plurality of past ticket transactions.

10. The computer-implemented method of claim 9, further comprising:
determining a distance from a point in each section within the event venue associated with at least the portion of the past ticket transactions and the point of interest;
determining an angle from the point in each section within the event venue associated with at least the portion of the past ticket transactions and the point of interest; and
utilizing the distance from the point in each section within the event venue and the angle from the point in each section within the event venue to determine the seat desirability score for seats pertaining to at least the portion of the past ticket transactions.

11. The computer-implemented method of claim 1, wherein the pricing value is a function of the seat desirability score and the price pertaining to the associated ticket listing of the plurality of ticket listings.

12. A system configured for determining quality of seats and/or value of prices for seat tickets at event venues, the system comprising:
one or more hardware processors configured by machine-readable instructions to:
obtain, from a ticket server, a plurality of ticket listings for events at an event venue, the plurality of ticket listings being capable of being served to buyers, at least a portion of the plurality of ticket listings including one or more of an event identifier identifying a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings;
execute a trained machine-learning model on at least the portion of the plurality of ticket listings to obtain a seat desirability score for one or more seats associated with the portion of the plurality of ticket listings;
determine a pricing value for the portion of the plurality of ticket listings; and
cause display of at least one of the seat desirability score and the pricing value for at least one of the one or more seats associated with the portion of the plurality of ticket listings.

13. The system of claim 12, wherein the machine-readable instructions are further configured to:
obtain transaction data pertaining to a plurality of past ticket transactions, at least a portion of the plurality of past ticket transactions being associated with one or more seats for a past event at the event venue, the transaction data including one or more of: a type of event of the past event associated with at least the portion of the plurality of past ticket transactions, a venue seat configuration for the event associated with at least the portion of the plurality of past ticket transactions, and a seat identifier identifying one or more seats associated with at least the portion of the plurality of past ticket transactions;
obtain event venue manifest data, at least a portion of the event venue manifest data including one or more of: a type of event for each type of event for which an associated event venue is used, and a venue seat configuration associated with at least a portion of the event types, the event venue seat configuration including a seat identifier for at least a portion of the seats at the event venue, a seat location for at least the portion of the seats at the event venue, and a point of interest; and
train a machine-learning model using the transaction data and the event venue manifest data to determine a seat desirability score for a plurality of seats at the event venue and to obtain the trained machine-learning model, the seat desirability score for at least a portion of the plurality of seats at the event venue being dependent upon an event at the event venue, the event being associated with an event venue seat configuration and an event type.

14. The system of claim 13,
wherein the transaction data includes information related to past ticket transactions associated with a plurality of event venues for which the ticket server is configured to serve tickets to buyers, and
wherein the event venue manifest data includes information related to the plurality of venues for which the ticket server is configured to serve tickets to buyers.

15. The system of claim 12, wherein the seat desirability score is determined for the one or more seats associated with the portion of the plurality of ticket listings by applying the trained machine learning model to the one or more seats.

16. The system of claim 12, wherein the one or more hardware processors are further configured by machine-readable instructions to:
receive a new ticket listing for one or more tickets capable of being served to buyers by the ticket server, the new ticket listing including one or more of: an event venue identifier identifying an event venue pertaining to the new ticket listing, an event identifier identifying a type of event pertaining to the new ticket listing, a seat identifier identifying a seat associated with the new ticket listing, and a price for the seat associated with the new ticket listing;
execute the trained machine-learning model on the new ticket listing to obtain a seat desirability score for the seat associated with the new ticket listing;
determine a pricing value for the seat associated with the new ticket listing; and
store the new ticket listing with the seat desirability score and pricing value for the seat associated therewith in the lookup table.

17. The system of claim 12, wherein the one or more hardware processors are further configured by machine-readable instructions to:
receive a request for a ticket for a seat having a strong seat desirability score for an event at the event venue;
determine one or more ticket listings of the plurality of ticket listings having the strong seat desirability score; and
cause display of at least one of the one or more ticket listings.

18. The system of claim 12, wherein the one or more hardware processors are further configured by machine-readable instructions to:
receive a request for a ticket for a seat having a strong pricing value for an event at the venue;
determine one or more ticket listings of the plurality of ticket listings having the strong pricing value; and
cause display of at least one of the one or more ticket listings.

19. A non-transient computer-readable storage medium having instructions embodied thereon, the instructions being executable by one or more processors to perform a method for determining quality of seats and/or value of prices for seat tickets at event venues, the method comprising:
one or more hardware processors configured by machine-readable instructions to:
obtain, from a ticket server, a plurality of ticket listings for events at an event venue, the plurality of ticket listings being capable of being served to buyers, at least a portion of the plurality of ticket listings including one or more of an event identifier identifying a type of event pertaining to an associated ticket listing of the plurality of ticket listings, a seat identifier identifying a seat pertaining to the associated ticket listing of the plurality of ticket listings, and a price pertaining to the associated ticket listing of the plurality of ticket listings;
execute a trained machine-learning model on at least the portion of the plurality of ticket listings to obtain a seat desirability score for one or more seats associated with the portion of the plurality of ticket listings;
determine a pricing value for the portion of the plurality of ticket listings; and
cause display of at least one of the seat desirability score and the pricing value for at least one of the one or more seats associated with the portion of the plurality of ticket listings.

20. The computer-storage medium of claim 19, wherein the one or more hardware processors are further configured by the machine-readable instructions to:
receive a new ticket listing for one or more tickets capable of being served to buyers by the ticket server, the new ticket listing including one or more of: an event venue identifier identifying an event venue pertaining to the new ticket listing, an event identifier identifying a type of event pertaining to the new ticket listing, a seat identifier identifying a seat associated with the new ticket listing, and a price for the seat associated with the new ticket listing;
execute the trained machine-learning model on the new ticket listing to obtain a seat desirability score for the seat associated with the new ticket listing;
determine a pricing value for the seat associated with the new ticket listing; and
store the new ticket listing with the seat desirability score and pricing value for the seat associated therewith in the lookup table.
